(19) United States
(12) Patent Application Publication
(10) Pub. No.: US 2018/0349205 A1
(43) Pub. Date: Dec. 6, 2018

(54) MULTI-PROCESSOR WORKLOAD DISTRIBUTION BASED ON SENSOR DATA

(71) Applicant: Faraday&Future Inc., Gardena, CA (US)

(72) Inventors: Sethu Hareesh Kolluru, Fremont, CA (US); Luke Michael Ekkizogloy, Mountain View, CA (US); Yunwei Liu, Alameda, CA (US); Xiufeng Song, San Jose, CA (US)

(21) Appl. No.: 15/613,084

(22) Filed: Jun. 2, 2017

Related U.S. Application Data
(60) Provisional application No. 62/345,668, filed on Jun. 3, 2016.

(51) Int. Cl. G06F 9/50; H04L 29/08; G06F 11/30

(52) U.S. Cl. CPC G06F 9/5083; G06F 9/505; G06F 2209/5022; G06F 11/3058; G06F 2201/81; H04L 67/12

(57) ABSTRACT

Systems and methods are described for distributing multi-processor workload based on sensor data. A method for managing processing workload within a vehicle includes receiving at least one measurement corresponding to a first processor of a plurality of processors installed in the vehicle; determining that the at least one measurement has satisfied a threshold; identifying a second processor of the plurality of processors installed in the vehicle, based on a type of the second processor or a measurement of an environment associated with the second processor; and distributing workload from the first processor to the second processor.

### CROSS-REFERENCE TO RELATED APPLICATIONS

This application claims the benefit of U.S. Provisional Application No. 62/345,668, filed Jun. 3, 2016, the entirety of which is hereby incorporated by reference.

### BACKGROUND

Modern vehicles, such as cars, vans, trucks, and the like, have become increasingly complex as new features are introduced to improve vehicle connectedness, autonomy, entertainment, luxury, and performance. To enable such new features, multiple computer processors are often implemented in a single vehicle.

Incorporating more processors in a vehicle is not without difficulties. Processors involved in computationally-intensive and/or often-used features may become overworked, causing heat dissipation and performance/power consumption inefficiencies. Additionally, ambient temperature from the environment in and around the vehicle may exacerbate heat dissipation and related issues. Thus, there is a need for improved design of multi-processor systems within a modern vehicular context.

### SUMMARY

Embodiments provide systems, methods, and apparatuses for balancing the workload in a multi-processor system. One processor of the multi-processor system may be designated as a primary processor and the rest of the processors may be designated as secondary processors. The primary processor may be configured to control the workflow in the multi-processor system. The primary processor may designate workflow to the secondary processors based on processor type and measured sensor information from sensors disposed proximate to corresponding secondary processors. Some embodiments herein control or influence the distribution of workload to each processor in the system such that the likelihood of overworking a processor in the multi-processor system is minimized.

In some embodiments, a method for managing processing workload within a vehicle includes receiving at least one measurement corresponding to a first processor of a plurality of processors installed in the vehicle; determining that the at least one measurement has satisfied a threshold; identifying a second processor of the plurality of processors installed in the vehicle, based on a type of the second processor or a measurement of an environment associated with the second processor; and distributing workload from the first processor to the second processor.

The at least one measurement may corresponding to the first processor may include a temperature of the first processor. In some embodiments, the measurement of the environment associated with the second processor may represent a temperature of the environment surrounding the second processor. The measurement of the environment associated with the second processor may represent an amount of vibration experienced at the environment surrounding the second processor. In certain embodiments, determining that the at least one measurement has satisfied the threshold may include determining that a temperature of the first processor has exceeded a processor temperature threshold. In some embodiments, identifying the second processor may be further based on a temperature of the second processor, wherein the second processor is identified upon determining that the temperature of the second temperature is lower than the threshold by a predetermined amount. The predetermined amount may be determined based on the distributed workload from the first processor to the second processor. In certain embodiments, identifying the second processor based on the measurement of the environment of the second processor may include determining that a temperature of an environment surrounding the second processor is lower than an environment condition threshold. In some embodiments, identifying the second processor based on the type of the second processor may include determining that the second processor and the first processor are the same type of processors.

In some embodiments, an apparatus for managing processing workload within a vehicle includes means for receiving at least one measurement corresponding to a first processor of a plurality of processors installed in the vehicle; means for determining that the at least one measurement has satisfied a threshold; means for identifying a second processor of the plurality of processors installed in the vehicle, based on a type of the second processor or a measurement of an environment associated with the second processor; and means for distributing workload from the first processor to the second processor.

The at least one measurement corresponding to the first processor may include a temperature of the first processor. The measurement of the environment associated with the second processor may represent a temperature of the environment surrounding the second processor. The measurement of the environment associated with the second processor may represent an amount of vibration experienced at the environment surrounding the second processor. In certain embodiments, determining that the at least one measurement has satisfied the threshold may include determining that a temperature of the processor has exceeded a processor temperature threshold. In some embodiments, identifying the second processor may be further based on a temperature of the second processor, wherein the second processor is identified upon determining that the temperature of the second temperature is lower than the threshold by a predetermined amount

In some embodiments, a system for managing processing workload for a vehicle includes a plurality of sensors, each sensor positioned at a location of the vehicle, and configured to measure a condition of its surrounding environment within a measurable range; and a plurality of processors, each processor being positioned within the measurable range of respective sensors of the plurality of sensors, and having a processor type, wherein one of the plurality of processors is designated as a primary and the other processors are designated as secondary processors. The primary processor may be configured to receive at least one measurement corresponding to a first processor of a plurality of processors installed in the vehicle; determine that the at least one measurement has satisfied a threshold; identify a second processor of the plurality of processors installed in the vehicle, based on a type of the second processor or a measurement of an environment associated with the second processor; and distribute workload from the first processor to the second processor.

The primary processor may be further configured to manage the workload of the secondary processor based on a current workload of the secondary processor. The first and second processors may be secondary processors. The first processor may be the primary processor and the second processor may be the secondary processor. In certain embodiments, the first processor may be the secondary processor and the second processor may be the primary processor.

A better understanding of the nature and advantages of some embodiments of the present disclosure may be gained with reference to the following detailed description and the accompanying drawings.

### BRIEF DESCRIPTION OF THE DRAWINGS

FIG. 1 is a simplified diagram illustrating a side view of a multi-processor system in a vehicle, according to certain embodiments of the present disclosure.

FIG. 2 is a simplified diagram illustrating a top view of a multi-processor system with sensors in a vehicle, according to certain embodiments of the present disclosure.

FIG. 3 is a simplified diagram illustrating a scenario where the multi-processor system is being subjected to a directional heat source, according to certain embodiments of the present disclosure.

FIG. 4 is a simplified diagram illustrating a scenario where the multi-processor system is being subjected to a directional cooling source, according to certain embodiments of the present disclosure.

FIG. 5 is a simplified diagram illustrating a scenario where the multi-processor system is being subjected to localized vibration, according to certain embodiments of the present disclosure.

FIG. 6 is a flow chart illustrating a method of managing processor workload, according to certain embodiments of the present disclosure.

FIG. 7 is an exemplary system for managing processor workload, according to certain embodiments of the present disclosure.

FIG. 8 is an exemplary apparatus for managing processor workload, according to certain embodiments of the present disclosure.

### DETAILED DESCRIPTION

Embodiments of the present disclosure describe a system and method for balancing workload distribution in a multi-processor system. The multi-processor system may be a modern vehicle, e.g., an electric car, capable of advanced features such as providing an infotainment system and performing autonomous driving.

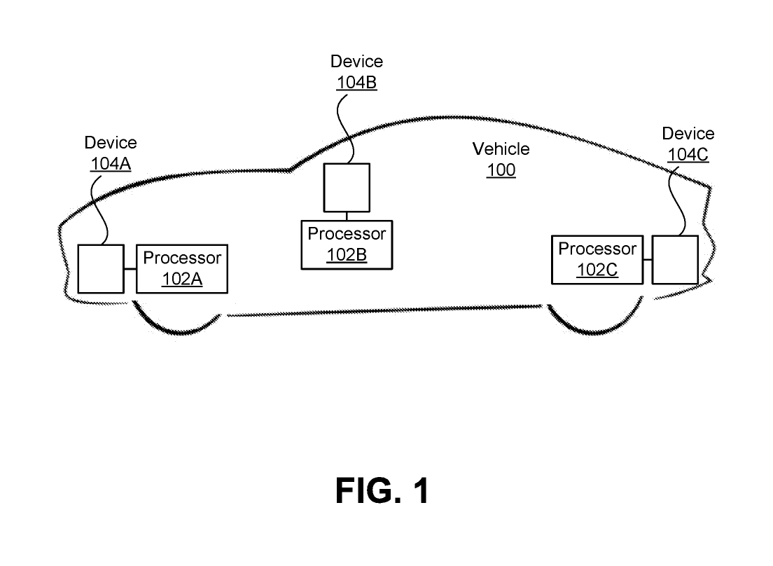

For instance, FIG. 1 is a simplified side-view illustration of an exemplary vehicle 100 according to some embodiments of the present disclosure. A plurality of processors may be implemented in vehicle 100 to perform one or more features, e.g., running an infotainment system, performing autonomous driving, and the like. As an example, vehicle 100 may include processors 102A-102C. Each processor may be any suitable processor configured to perform one or more functions, e.g., a multi-core processor, field programmable gate array (FPGA), application central processing unit (CPU), application specific integrated circuit (ASIC), graphics processing unit (GPU), or another type of processor.

Each processor may be coupled to one or more devices, which may be configured to perform one or more functions that provide information to, be controlled by, and/or be otherwise associated with the processor. While each processor may be coupled to more than one device, and each device may be coupled to more than one processor, FIG. 1 shows a simple arrangement of one device connected to each processor for illustrative purposes. As shown in FIG. 1, processor 102A may be coupled to device 104A, processor 102B may be coupled to device 104B, and processor 102C may be coupled to device 102C. For example, device 104A may be a proximity sensor for detecting proximity to nearby objects or an infrared/laser camera for monitoring objects in front of vehicle 100; thus, processor 102A may be a GPU or an application CPU configured to process images captured by device 104A. Device 104B may be a computer for operating an infotainment system; thus, processor 102B may be a high performance multi-core processor for performing functions related to the infotainment system, e.g., playing video, playing music, and/or displaying a map on a display screen. Similar to device 104A, device 104C may be a proximity detector or a camera for detecting objects behind vehicle 100; thus, processor 102C may be a GPU or an application CPU configured to process images captured by device 104C.

As can be appreciated herein, processors 102A-102C may be different types of processors in some embodiments, similar types of processors in other embodiments, or be configured such that some processors are similar types of processors while other processors are different types of processors in yet other embodiments, where each processor is chosen to complement one or more functions or one or more types of functions, such as those performed by devices 104A-104C. For instance, processors 102A and 102B may be GPUs having processor architectures that are more suitable for processing detailed images at a high throughput, e.g, an architecture optimized for Same Instruction Multiple Data (SIMD) processing. Processor 102B may be a multi-core processor having a process architecture that is specifically designed for executing different instruction sequences at the same time, e.g., an architecture optimized for multi-threaded processing. Thus, some processors may be more suitable for performing certain functions over other processors.

Although FIG. 1 illustrates exemplary vehicle 100 as having only three processors 102A-102C and three devices 104A-104C, embodiments are not limited to such configurations. In certain embodiments, vehicle 100 may have more or less than three processors and three devices. Furthermore, even though vehicle 100 has the same number of processors as devices, certain embodiments may have a number of processors that is different than the number of devices. The configuration of vehicle 100 is shown for ease of discussion, and any combination or number of processors and devices are envisioned herein without departing from the spirit and scope of the present disclosure.

According to some embodiments of the present disclosure, processors 102A-102C may be coupled together such that the workload from one processor may be distributed to another processor. The distribution of workload between processors may be managed by a processor designated as a primary processor, while the processors whose workloads are being distributed may be designated as secondary processors. The primary processor may distribute workload amongst various processors, including the primary itself and the secondary processors, based on factors such as processor temperature, processor type, and environmental conditions (measured by one or more sensors), as will be discussed further herein.

Workflow distribution may be suitable for instances where one or more processors are being overworked or predicted to have overloading issues. Overworked processors tend to emit a large amount of heat and dissipate a large amount of power, while performing at a reduced performance level as a result of the increased heat generation and power dissipation. In other words, overworked processors require more power to run, run inefficiently, and require additional power to cool (e.g., in instances where processors are water cooled or fan cooled). Thus, it may be desirable to distribute workload across available processors such that the overloading of processors can be minimized or substantially prevented.

### I. Multi-Processor System With Sensors

In some embodiments, a plurality of sensors may be incorporated in the multi-processor system. Each sensor may be positioned to measure the surrounding environment of a corresponding processor. The primary processor may receive information from the sensor about the surrounding environment of the corresponding secondary processor, and use that information to manage the workflow for each processor in the multi-processor system.

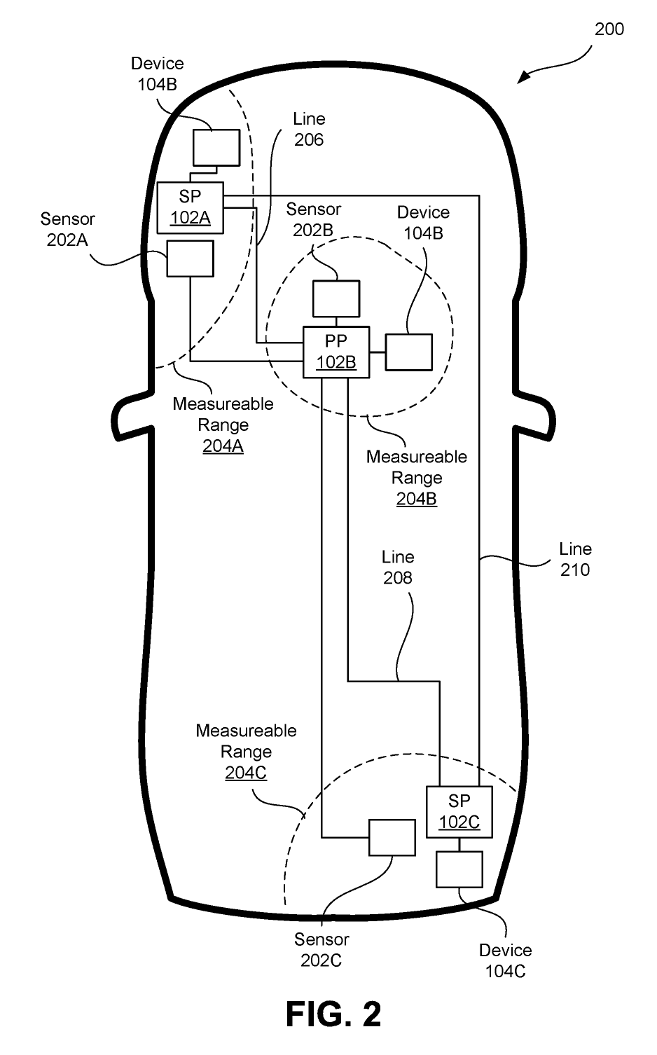

FIG. 2 is a top-down view of a simplified diagram illustrating an exemplary vehicle configured as a multi-processor system 200 with sensors 202A-202C, according to some embodiments of the present disclosure. FIG. 2 may be a top-down view of FIG. 1, with the addition of sensors 202A-202C in the multi-processor system. Processors 102A-102C may be physically separated from one another. They may be disposed at least one foot away from one another, such as a few feet from one another in certain embodiments. As shown in FIG. 2, sensors 202A-202C may be positioned proximate to respective processors 102A-102C. For instance, sensors 202A, 202B, and 202C may be positioned near processors 102A, 102B, and 102C, respectively. Each sensor may be capable of detecting one or more environmental conditions within a measurable range, and each respective processor may be positioned within the measurable range of the corresponding sensor. As an example, processor 102A may be positioned within a measurable range 204A of sensor 202A, such that sensor 202A may be capable of measuring the surrounding environment of processor 102A. The same relationship may exist for sensor 202B, measurable range 204B, and processor 102B, as well as sensor 202C, measurable range 204C, and processor 202C.

Sensors 202A-202C may be any suitable sensor capable of measuring a condition (e.g., property) of a surrounding environment. In some embodiments, sensors 202A-202C may be temperature sensors, vibration sensors, humidity sensors, light sensors, microphones, and/or another type of environment sensor. Each sensor may measure a condition of the surrounding environment and transmit information pertaining to the measured condition of the surrounding environment to a processor, such as a secondary processor or a primary processor configured to manage the workload distribution of the multi-processor system.

In the exemplary embodiment shown in FIG. 2, processor 102B may be designated as a primary processor (labeled as “PP” in FIG. 2), and processors 102A and 102C may be designated as secondary processors (labeled as “SP” in FIG. 2). Thus, in some embodiments, sensors 202A-202C may be coupled to primary processor 102B. Primary processor 102B may be configured to manage the workflow distribution in multi-processor system 200 (e.g., among secondary processors 102A and 102C and primary processor 102B) based on one or more criteria. For instance, workflow distribution may be based on criteria such as, but not limited to, processor availability, type of processor, and/or surrounding environment conditions.

Although FIG. 2 illustrates processor 102B as the primary processor and processors 102A and 102C as the secondary processors, it is to be understood that the illustrated configuration is only one example, and it not intended to be limiting. Here, processor 102A may be the primary processor, and sensors 202A-202C may be coupled to processor 102A to balance workload distribution. Alternatively or additionally, processor 102C may be the primary processor. Furthermore, it is to be appreciated that the designation of primary and secondary can dynamically change based upon the circumstances. For instance, if the current primary processor fails, a secondary processor may be designated as a primary processor and thus manage the workload balance of other processors. In some embodiments, every sensor may be coupled to all processors, and such a configuration may facilitate more efficient dynamic assignment of primary and secondary roles for processors. At any rate, it is understood that various arrangements of primary and secondary processors are envisioned herein.

### II. Balancing Workload Distribution

Primary processor 102B may be configured to balance the workload distribution across all three processors 102A-102C. In some embodiments, primary processor 102B may monitor the operation of secondary processors 102A and 102C, and/or periodically receive status information from secondary processors 102A and 102C, to ensure that the secondary processors 102A and 102C do not have too high of a workload. Additionally, primary processor 102B may monitor the surrounding environment of each secondary processor 102A and 102C using sensors 202A and 202C to appropriately adjust the distribution of work between secondary processors 102A and 102C, or amongst processors 102A, 102B, and 102C, in a manner that takes into consideration the corresponding environmental conditions. For example, the distribution may be chosen to avoid operation of one or more of processors 102A, 102B, and 102C in extreme conditions. Extreme conditions may include high temperatures, high vibration, etc. Operating in extreme conditions may also cause processors such as secondary processors 102A and 102C, as well as primary processor 102B, to be become overworked. This can occur, for example, when a processor operates beyond its intended activity level for a particular temperature or temperature range. Operating in extreme conditions can also prevent the processor from being able to cool down, thereby extending or exacerbating an overheating episode.

### A. Determining When Processors Need Relief

According to some embodiments, primary processor 102B may identify which processors need relief, i.e., are close to being, if not already, overworked. An overworked processor may be a processor that is operating under extreme conditions, e.g., when the surrounding environment is at a high temperature or when the processor has a workload that causes the processor to generate excessive heat and dissipate excessive power. For instance, primary processor 102B may monitor the temperature and the surrounding environment of each secondary processor 102A and 102C. The temperature of each secondary processor 102A and 102C may be monitored by way of status updates via transmission of status information. The surrounding environment may be monitored using readings from sensors 202A and 202C. If the temperature and/or the surrounding environment for either secondary processor 102A or 102C crosses a processor temperature threshold or an environment condition threshold, respectively, then primary processor 102B may determine that the secondary processor needs relief and may transfer tasks from that secondary processor to another processor or to primary processor 102B itself. It is to be appreciated that primary processor 102B may also monitor its own workload and surrounding environment to determine if it needs relief as well. If primary processor 102B determines that it needs relief, then primary processor 102B may transfer tasks from itself to one or more secondary processors 102A and/or 102C.

A processor temperature threshold may be a temperature or a range of temperatures indicative of when a processor is being overworked, i.e., generating excessive heat and/or dissipating excessive power to a point where the processor is working inefficiently. Exemplary processor temperature thresholds may range between 40° C. and 150° C. In a particular embodiment, the processor temperature threshold may be approximately 50° C.

An environment condition threshold may be related to a temperature or a range of temperatures of a processor's surrounding environment that is indicative of whether the processor will be overworked in the near future. For instance, the environment condition threshold may be a temperature that, if imposed on a processor, could cause the processor to easily reach the processor temperature threshold just by exposure to the temperature of that surrounding environment. Exemplary environment condition thresholds may be a temperature offset from the processor temperature threshold by a thermal diffusion coefficient corresponding to a temperature loss through a processor's housing. An environment condition threshold may range between 0° C. and 50° C. In a particular embodiment, the environment condition threshold may be approximately 35° C.

In some embodiments, the environment condition threshold may be related to a degree of physical stress occurring in an environment surrounding a processor. For example, the environment condition threshold may be an amount of vibration occurring in an environment surrounding a processor. If the force of vibration is too high, then the processor may not perform efficiently. For instance, an environment condition threshold with regard to vibration force may range between 500 Hz and 2,000 Hz. In a particular embodiment, the environment condition threshold may be approximately 1,000 Hz.

The processor whose temperature has crossed the processor temperature threshold and/or whose surrounding environment has crossed the environment condition threshold may be determined to be a processor that needs relief.

### B. Identifying Which Processors Can Provide Relief

Once a processor has been determined by a primary processor to need relief, e.g., has reached the processor temperature threshold or is being exposed to an environment condition threshold, workload distributed to that processor may be transferred to one or more relief processors. The relief processor may be any processor in the multi-processor system that is not the processor that needs relief, such as another secondary processor and/or the primary processor itself. Identification of the relief processor for receiving the transferred workload may be based on several factors, such as, but not limited to, the relief processor's processor type, the relief processor's current temperature, and/or the temperature of the relief processor's surrounding environment. These factors may all be considered when determining which processor is to be the relief processor.

Processor type may be considered when identifying a relief processor because depending on the processor that needs relief, some processors may be more suited and/or better configured to receive and execute the transferred tasks. For instance, if a GPU is a processor that needs relief, then a relief processor that is also a GPU may be preferred over a relief processor that is not a GPU. In such instances, transferred tasks and/or specific programmed instructions need not be changed or altered and may be more easily transferred.

Processor temperature is also considered when identifying a relief processor because it may be important to ensure that the relief processor has the ability to support the additional transferred workload. The processor temperature may be a direct indication of the processor's workload. Processors under high workloads may have high processor temperatures due to the thermal energy given off when power is dissipated to perform tasks. Thus, processors with high temperatures may indicate that these processors have high workloads. If a candidate processor is already reaching or close to reaching a processor temperature threshold, then that processor may be close to being overworked and may be determined to not be a suitable relief processor. Identifying whether a candidate processor is a suitable relief processor may involve determining whether the candidate processor's temperature is lower than the processor temperature threshold. In certain embodiments, the candidate processor's temperature may be lower than the processor temperature threshold by a predetermined amount. The predetermined amount may be a buffer range of temperature to compensate for the anticipated rise in temperature from the additional transferred workload.

In some embodiments, the surrounding environment is also considered when identifying a relief processor because it may be important to know how easily the candidate processor is able to dissipate the heat generated by the additional transferred workload. If a condition of the surrounding environment of a candidate processor is unfavorable, e.g., close to the environment condition threshold, then the candidate processor may not be a good relief processor because it may easily rise in temperature as it performs the additional transferred workload. On the other hand, if the condition of the surrounding environment of the candidate processor is favorable, e.g., far below the environment condition threshold, then the candidate processor may be a good relief processor because it may be easy for the candidate processor to dissipate any heat generated from the additional transferred workload. That is, the low temperature of the surrounding environment may assist in heat dissipation. It is to be appreciated that the condition of the environment includes a temperature of the environment and an amount of vibration existing around the environment. In certain embodiments, the surrounding environment may also include a cooling mechanism or procedure for the processor. If the processor is being cooled by a stronger mechanism or procedure, such as liquid cooling, then it may be preferred over another processor with a relatively weaker cooling mechanism or procedure, such as fan cooling.

Thus, according to some embodiments herein, the relief processor may be determined based on processor type, processor temperature, and/or the processor's surrounding environment. If the processor type is similar to the processor that needs relief, the processor's temperature is lower than the processor temperature threshold, and/or the condition of the surrounding environment is favorable in view of the environment condition threshold, then the processor may be identified as a very favorable relief processor.

### C. Example Workload Balancing Scenarios

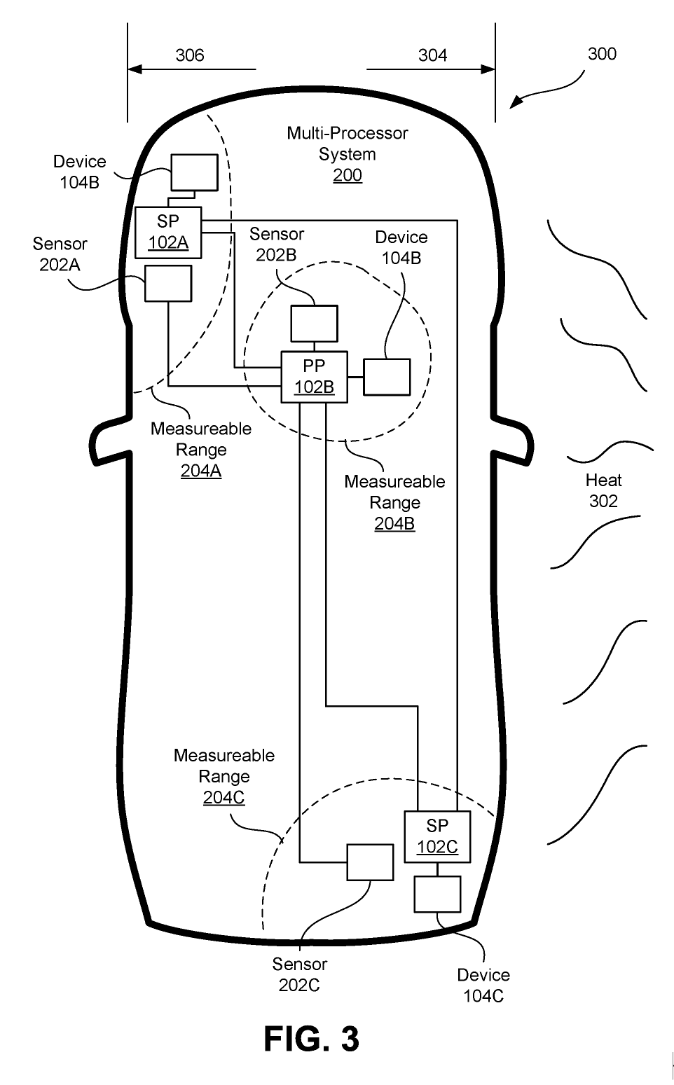

In some embodiments, the processor that needs relief and the selected relief processor may constantly change in real world scenarios depending on the circumstances surrounding the multi-processor system. FIGS. 3, 4, and 5 illustrate a few exemplary scenarios where certain processors are determined to need relief, and certain processors are identified as relief processors. The scenarios discussed in FIGS. 3, 4, and 5 assume that the candidate processors are not above a processor temperature threshold.

FIG. 3 is a simplified diagram illustrating a scenario 300 where a multi-processor system (e.g., multi-processor system 200 illustrated as a vehicle) is subjected to heat 302 emitted from one direction. Secondary processors 102A and 102C may be GPU type processors and primary processor 102B may be a multi-core application CPU type processor. Scenario 300 may occur when the multi-processor system 200 is sitting in traffic or moving very slowly, and is extensively running its infotainment system. The infotainment system may be performed by processor 102B, which may be designated as a primary processor. In scenario 300, primary processor 102B may determine that its processor temperature is reaching, has reached, or has exceeded a processor temperature threshold. Thus, primary processor 102B may need to identify one or more relief processors to help process tasks.

Because the temperature of primary processor 102B indicates that primary processor 102B is overworked, the candidate processors (e.g., processors that could potentially be relief processors for receiving transferred workload from primary processor 102B) may be secondary processors 102A and 102C. Primary processor 102B may weigh one or more factors for each candidate processor. For instance, primary processor 102B may weigh the processor type, processor temperature, and/or the condition of the surrounding environment of secondary processors 102A and 102C. In scenario 300, primary processor 102B may determine that secondary processor 102C is positioned on a right side 304 of the multi-processor system 200. In scenario 200, right side 304 of multi-processor system 200 may be exposed to extreme heat 302, such as from the sun in the early afternoon. Accordingly, sensor 202C may detect that the temperature of the surrounding environment within measureable range 204C of secondary processor 102C is abnormally high, e.g., close to the environment condition threshold. Thus, primary processor 102B may determine that secondary processor 102C may not be a good candidate to be a relief processor, and may thus select processor 102A, which is positioned on a left side 306 (e.g., cooler side) of multi-processor system 200.

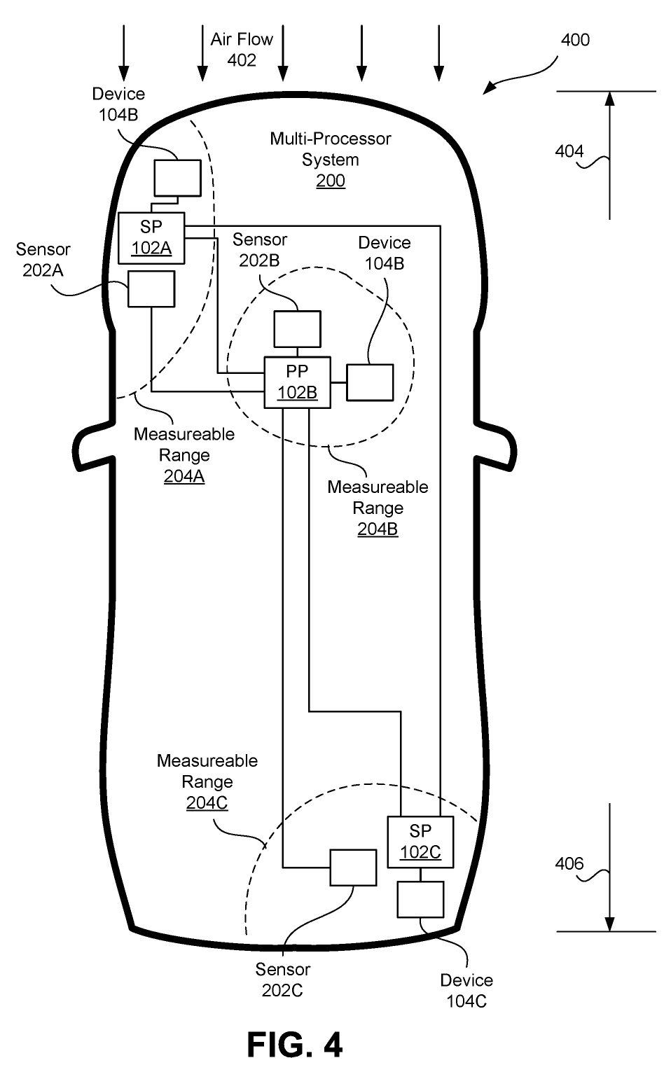

FIG. 4 is a simplified diagram illustrating a scenario 400 where multi-processor system 200 is traveling on a highway or on a long stretch of road where air flow 402 is blowing against a front end 404 of multi-processor system 200 at high speed. Here for purposes of illustration, secondary processors 102A and 102C may be multi-core application CPU type processors and primary processor 102B may be a GPU type processor. In scenario 400, multi-processor system 200 may be operating in autonomous driving mode. In such a mode, the multi-processor system 200 may be driving without direct user intervention but according to a plethora of sensor information. Secondary processor 102C may be responsible for performing the necessary calculations required for autonomous driving. Thus, given the high workload of secondary processor 102C, primary processor 102B may determine that the processor temperature of secondary processor 102C is about to reach, has reached, or has exceeded a processor temperature threshold. Thus, primary processor 102B may need to identify one or more relief processors to help process tasks.

Because the temperature of secondary processor 102C indicates that secondary processor 102C is overworked, the candidate processors are secondary processor 102A and primary processor 102B. Primary processor 102B may weigh one or more factors for each candidate processor. For instance, primary processor 102B may weigh the processor type, processor temperature, and/or the condition of the surrounding environment of processors 102A and 102B. In scenario 400, secondary processor 102A may be positioned at front end 404 of multi-processor system 200 which may be exposed to air flow 402. Accordingly, sensor 202A may detect that the temperature of the surrounding environment within measureable range 204A of secondary processor 102A is low, e.g., below the environment condition threshold. Additionally, primary processor 102B may determine that secondary processor 102A is the same processor type as secondary processor 102C. Thus, primary processor 102B may determine that secondary processor 102A may be a good candidate to be a relief processor. Even if the surrounding environment of primary processor 102B is also below the environment condition threshold, primary processor 102B may still determine secondary processor 102A to be the relief processor because secondary processor 102A is the same processor type as secondary processor 102C.

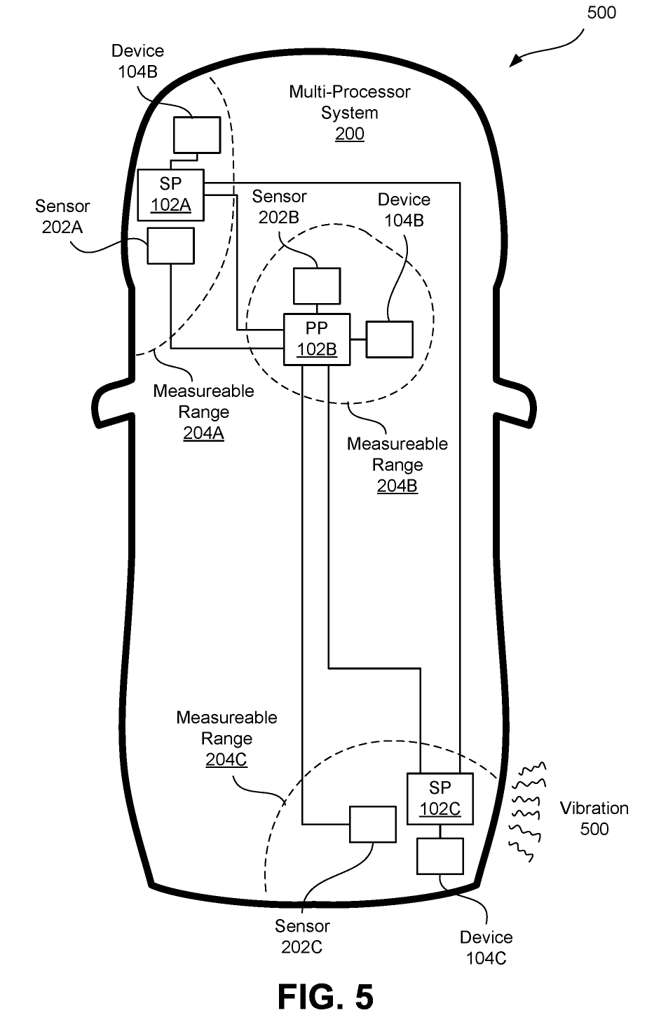

FIG. 5 is a simplified diagram illustrating a scenario 500 where a multi-processor system 200 is subjected to abnormal vibration in an area of multi-processor system 200, such as when a wheel is misaligned. Secondary processors 102A and 102C may be GPU type processors and primary processor 102B may be a multi-core application CPU type processor. Scenario 500 may occur when the multi-processor system 200 is driving on a road and is extensively running its infotainment system. The infotainment system may be performed by primary processor 102B. In scenario 500, primary processor 102B may determine that it is reaching, has reached, or has exceeded a processor temperature threshold, and may thus need to identify one or more relief processors to help process tasks.

In scenario 500, the candidate processors may be secondary processors 102A and 102C. Secondary processor 102C may be positioned in an area with an abnormal amount of vibration 502 caused by the misaligned wheel rotating against the road. Accordingly, sensor 202C may detect that the surrounding environment within measureable range 204C of secondary processor 102C has a large amount of vibration. Thus, primary processor 102B may determine that secondary processor 102C is in an environment that has an amount of vibration greater than an environment condition threshold, and thus determine that processor 102C may not be a good candidate to be a relief processor. Accordingly, primary processor 102B may select processor 102A given that it does not have a high amount of vibration, is not in an environment having temperatures above a threshold, and/or is of a processor type that matches primary processor 102B.

Although FIGS. 3, 4, and 5 discuss identifying only one relief processor, embodiments are not so limited. For instance, more than one relief processor may be selected in some embodiments. It is to be appreciated that any suitable processor or number of processors can be selected to be relief processor(s) to help process tasks from the processor needing relief without departing from the spirit and scope of the present disclosure.

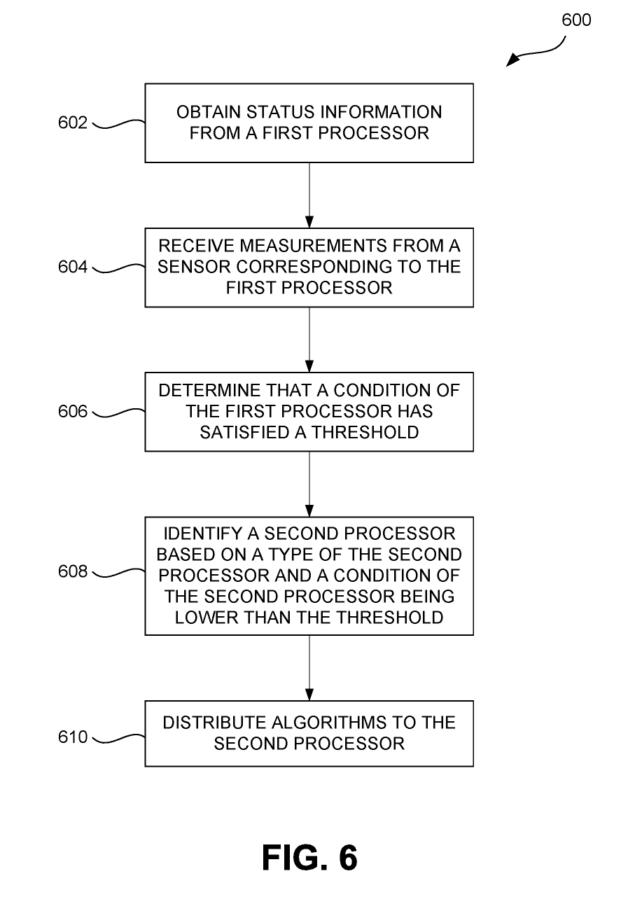

FIG. 6 is a flow diagram showing a process 600 of balancing workload distribution according to some embodiments of the present disclosure. At step 602, status information from a first processor may be obtained. For instance, a primary processor may receive status information from one or more secondary processors regarding its current processor temperature. In certain embodiments, receiving status information includes determining a processor's own status information. As an example, the primary processor may query itself to determine its own processor temperature. The processor temperature may be a temperature measured from a physical substrate of the processor, such as a semiconductor substrate and/or a packaging substrate. The first processor in some embodiments may be a secondary processor or a primary processor.

Thereafter, at block 604, measurements from a sensor corresponding to the first processor may be received. The sensor may be positioned proximate to the first processor such that the sensor may be capable of measuring a condition of a surrounding environment of the first processor. The first processor may be positioned within a measureable range of the sensor. In some embodiments, the sensor may be a temperature sensor configured to measure the temperature of air temperature surrounding the first processor. In certain embodiments, the sensor may be a vibration sensor configured to measure an intensity of vibration subjected to the first processor.

Once the information from the first processor and the surrounding environment of the first processor is received, at block 606, it may be determined that a condition of the first processor has satisfied a threshold. The threshold may be a processor temperature threshold, an environment condition threshold based on temperature, or an environment condition threshold based on vibration, as discussed herein with respect to FIG. 2.

If one or both of the thresholds are satisfied, then at block 608, a second processor may be identified. The second processor may be identified based on one or more factors, such as, but not limited to, processor type, current processor temperature, and the conditions of the second processor's surrounding environment, as discussed herein with respect to FIG. 2. In certain embodiments, the second processor may be one candidate processor amongst a plurality of candidate processors, where the second processor is identified because it is of a desirable processor type, its current processor temperature is lower than a threshold (e.g., processor temperature threshold), and/or the measured condition of its surrounding environment is lower than a threshold (e.g., environment condition threshold).

In some embodiments, merely being lower than a threshold may not be sufficient. Rather, the current temperature and/or the condition of the surrounding environment may need to be a predetermined amount lower than the threshold in order for the candidate processor to be identified at block 608. The predetermined amount may be a buffer amount defined by the anticipated amount of increase in temperature from performing additional workload that will be transferred from the first processor, as discussed herein with respect to FIG. 2. Although block 608 discusses identifying a second processor, it is to be appreciated that more than one processor may be identified, without departing from the spirit and scope of the present disclosure.

Once the second processor has been identified, at block 610, one or more tasks originally designated to be processed by the first processor may be distributed to the second processor (or one or more additional processors identified at block 608). Thus, the second processor may assist the first processor and help prevent the first processor from reaching a high operating temperature, i.e., operating inefficiently. In some embodiments, the tasks may be transferred directly from the first processor to the second processor through a designated line (wired or wireless). In some additional or alternative embodiments, the tasks may first be transferred to a primary processor and then relayed to the second processor.

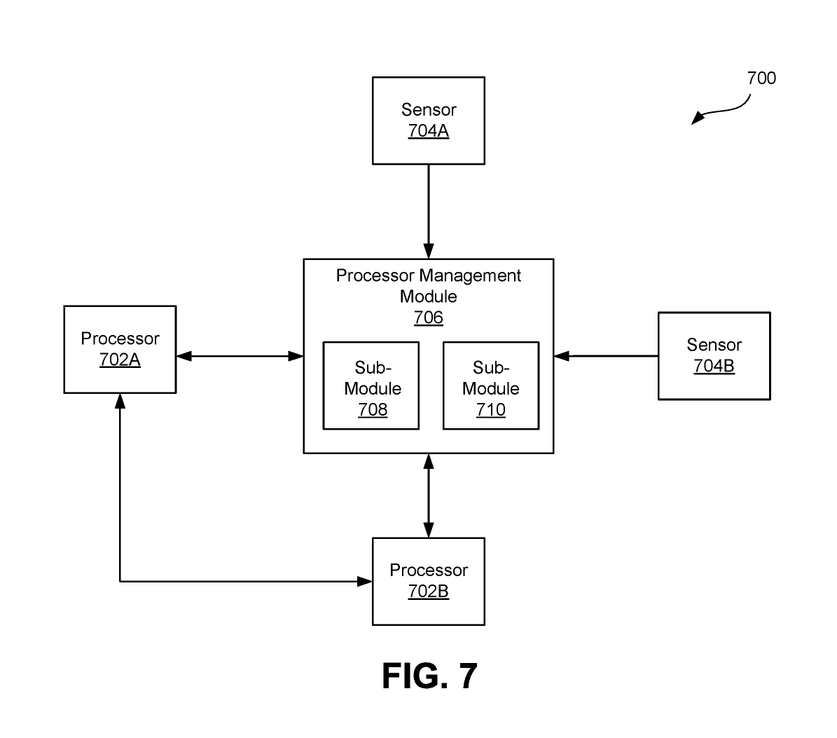

FIG. 7 is a simplified block diagram illustrating an exemplary multi-processor system 700 for balancing workload distribution in a multi-processor system, according to some embodiments of the present disclosure. In some embodiments, system 700 may include a plurality of processors, e.g., processors 702A and 702B. Processors 702A and 702B may be coupled to one another through a connection, which may comprise a bus such as a controller area network (CAN) bus. The connection may be implemented as a channel shared by various types of devices including different processors, sensors, etc. or may be implemented as a dedicated channel for inter-processor communications. Furthermore, the connection may be a wired or wireless connection. Similar to processors 102A-102C in FIG. 2, processors 702A and 702B may be any suitable processor configured to perform one or more functions, such as a GPU, FPGA, application CPU, ASIC, multi-core microprocessor, and the like.

System 700 may also include one or more sensors, such as sensors 704A and 704B. Sensors 704A and 704B may be positioned proximate to processors 702A and 702B such that sensors 704A and 704B may measure the surrounding environment of processors 702A and 702B. Details of their arrangement and purpose may be further referenced herein with respect to the discussion of sensors 202A-202C in FIG. 2.

Processor 702A and 702B may be configured to be managed by a processor management module 706. In certain embodiments, processor management module 706 may be software code configured to manage the distribution of processor workload across processors 702A and 702B. Processor management module 706 may be embedded within one or more processors. For instance, processor management module 706 may be embedded within a primary processor such that the primary processor is capable of managing processor workload distribution across several processors.

In some embodiments, processor management module 706 may include one or more sub-modules configured to perform one or more specialized tasks within the greater task of managing performance workload across multiple processors. For instance, processor management module 706 in FIG. 7 may include two sub-modules: sub-module 708 and sub-module 710. Sub-module 708 may be software code configured to determine when one or more processors need relief, such as when a processor is overworked, whereas sub-module 710 may be software code configured to identify which processors can provide relief for the overworked processors. The details of such functions may be further referenced herein with respect to FIG. 2.

Although processor management module 706 is shown as being located outside of processors 702A and 702B, processor management module 706 may be positioned within one or both of processor 702A and 702B. It is to be appreciated that processor management module 706 may be positioned in any location or embedded within any processor, as long as it is configured to receive information from processors 702A and 702B, as well as receive measured sensor information from sensors 704A and 704B.

### III. Example Apparatus

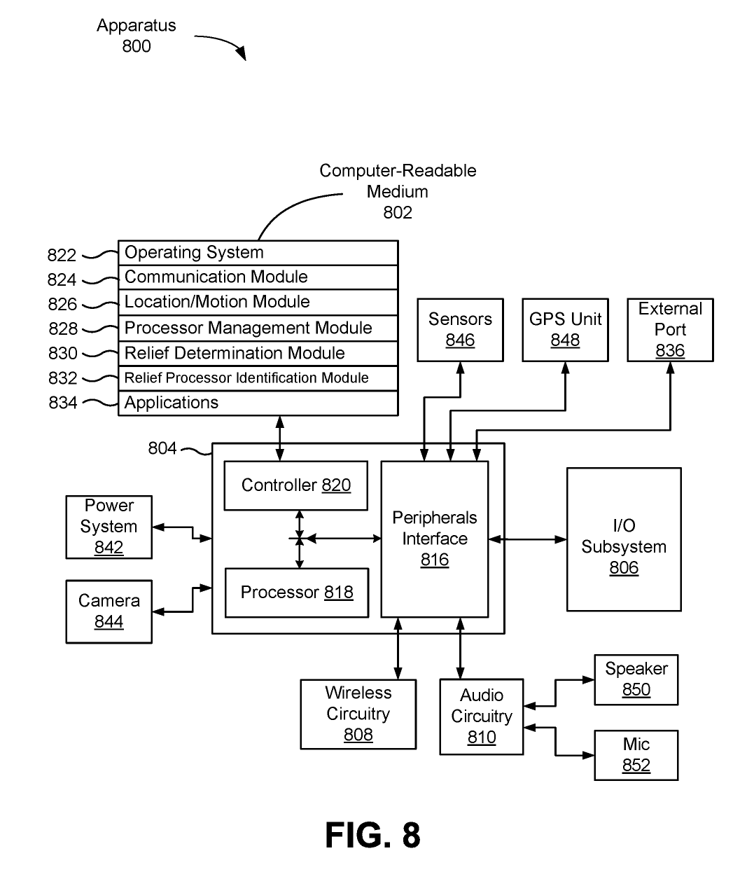

FIG. 8 is a block diagram of an example apparatus 800, which may be a vehicle. Apparatus 800 generally includes computer-readable medium 802, a processing system 804, an Input/Output (I/O) subsystem 806, wireless circuitry 808, and audio circuitry 810 including speaker 850 and microphone 852. These components may be coupled by one or more communication buses or signal lines. Apparatus 800 can be any vehicle, including a car, truck, van, bus, airplane, boat, motorcycle, or the like.

It should be apparent that the architecture shown in FIG. 8 is only one example of an architecture for apparatus 800, and that apparatus 800 can have more or fewer components than shown, or a different configuration of components. The various components shown in FIG. 8 can be implemented in hardware, software, or a combination of both hardware and software, including one or more signal processing and/or application specific integrated circuits.

Wireless circuitry 808 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc.

Wireless circuitry 808 is coupled to processing system 804 via peripherals interface 816. Interface 816 can include conventional components for establishing and maintaining communication between peripherals and processing system 804. Voice and data information received by wireless circuitry 808 (e.g., in speech recognition or voice command applications) is sent to one or more processors 818 via peripherals interface 816. One or more processors 818 are configurable to process various data formats for one or more application programs 834 stored on medium 802.

Peripherals interface 816 couple the input and output peripherals of the device to processor 818 and computer-readable medium 802. One or more processors 818 communicate with computer-readable medium 802 via a controller 820. Computer-readable medium 802 can be any device or medium that can store code and/or data for use by one or more processors 818.

Apparatus 800 also includes a power system 842 for powering the various hardware components. Power system 842 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in vehicles.

In some embodiments, apparatus 800 includes a camera 844. In certain embodiments, apparatus 800 includes sensors 846. Sensors 846 can include accelerometers, compasses, gyrometers, pressure sensors, audio sensors, light sensors, barometers, and the like. Sensors 846 can be used to sense an environment surrounding a processor within a measurable range.

In some embodiments, apparatus 800 can include a GPS receiver, sometimes referred to as a GPS unit 848. An apparatus can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the apparatus. Based on these estimations, the apparatus can determine a location fix, altitude, and/or current speed. A location fix can be geographical coordinates such as latitudinal and longitudinal information.

One or more processors 818 run various software components stored in medium 802 to perform various functions for apparatus 800. In certain embodiments where there are multiple processors 818, each processor may run software components stored in its respective medium. Thus, there may be multiple mediums 802 in certain embodiments. In some embodiments, the software components include an operating system 822, a communication module (or set of instructions) 824, a location module (or set of instructions) 826, a sensor location module 828, a probability determination module 830, a location predictor module 832, and other applications (or set of instructions) 834, such as a car locator app and a navigation app.

Operating system 822 can be any suitable operating system, including iOS, Mac OS, Darwin, RTXC, LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 824 facilitates communication with other devices over one or more external ports 836 or via wireless circuitry 808 and includes various software components for handling data received from wireless circuitry 808 and/or external port 836. External port 836 (e.g., USB, FireWire, Lightning connector, 60-pin connector, etc.) is adapted for coupling directly to other devices or indirectly over a network (e.g., the Internet, wireless LAN, etc.).

Location/motion module 826 can assist in determining the current position (e.g., coordinates or other geographic location identifier) and motion of apparatus 800. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 826 receives data from GPS unit 848 and analyzes the signals to determine the current position of the apparatus. In some embodiments, location/motion module 826 can determine a current location using Wi-Fi or cellular location technology. For example, the location of the apparatus can be estimated using knowledge of nearby cell sites and/or Wi-Fi access points with knowledge also of their locations. Information identifying the Wi-Fi or cellular transmitter is received at wireless circuitry 808 and is passed to location/motion module 826. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for apparatus 800 based on the position coordinates of the corresponding transmitters. Regardless of the specific location technology used, location/motion module 826 receives information from which a location fix can be derived, interprets that information, and returns location information, such as geographic coordinates, latitude/longitude, or other location fix data.

Processor management module 828 manage the workload between multiple processors, e.g., as described herein with respect to FIG. 2. Relief determination module 830 can determine when a processor is in need of relief, e.g., being overworked, as discussed herein with respect to FIGS. 6A-6B and 7. Relief processor identification module 832 can identify one or more relief processors for receiving additional workload to relieve the processor in need of relief.

The one or more applications 834 on the apparatus can include any applications installed on the apparatus 800, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

The I/O subsystem 806 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in additional or alternative embodiments.

In some embodiments, I/O subsystem 806 can include one or more displays and user input devices such as a keyboard, mouse, and/or track pad. In some embodiments, I/O subsystem 806 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 802) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, apparatus 800 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the apparatus's infotainment system. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

Although the disclosure has been described with respect to specific embodiments, it will be appreciated that the disclosure is intended to cover all modifications and equivalents within the scope of the following claims.

What is claimed is:

1. A method for managing processing workload within a vehicle, the method comprising:
receiving at least one measurement corresponding to a first processor of a plurality of processors installed in the vehicle;
determining that the at least one measurement has satisfied a threshold;
identifying a second processor of the plurality of processors installed in the vehicle, based on a type of the second processor or a measurement of an environment associated with the second processor; and
distributing workload from the first processor to the second processor.

2. The method of claim 1, wherein the at least one measurement corresponding to the first processor comprises a temperature of the first processor.

3. The method of claim 1, wherein the measurement of the environment associated with the second processor represents a temperature of the environment surrounding the second processor.

4. The method of claim 1, wherein the measurement of the environment associated with the second processor represents an amount of vibration experienced at the environment surrounding the second processor.

5. The method of claim 1, wherein determining that the at least one measurement has satisfied the threshold comprises:
determining that a temperature of the first processor has exceeded a processor temperature threshold.

6. The method of claim 1, wherein identifying the second processor is further based on a temperature of the second processor, wherein the second processor is identified upon determining that the temperature of the second temperature is lower than the threshold by a predetermined amount.

7. The method of claim 6, wherein the predetermined amount is determined based on the distributed workload from the first processor to the second processor.

8. The method of claim 1, wherein identifying the second processor based on the measurement of the environment of the second processor comprises determining that a temperature of an environment surrounding the second processor is lower than an environment condition threshold.

9. The method of claim 1, wherein identifying the second processor based on the type of the second processor comprises determining that the second processor and the first processor are the same type of processors.

10. An apparatus for managing processing workload within a vehicle, comprising:
means for receiving at least one measurement corresponding to a first processor of a plurality of processors installed in the vehicle;
means for determining that the at least one measurement has satisfied a threshold;
means for identifying a second processor of the plurality of processors installed in the vehicle, based on a type of the second processor or a measurement of an environment associated with the second processor; and
means for distributing workload from the first processor to the second processor.

11. The apparatus of claim 10, wherein the at least one measurement corresponding to the first processor comprises a temperature of the first processor.

12. The apparatus of claim 10, wherein the measurement of the environment associated with the second processor represents a temperature of the environment surrounding the second processor.

13. The apparatus of claim 10, wherein the measurement of the environment associated with the second processor represents an amount of vibration experienced at the environment surrounding the second processor.

14. The apparatus of claim 10, wherein determining that the at least one measurement has satisfied the threshold comprises:
determining that a temperature of the processor has exceeded a processor temperature threshold.

15. The apparatus of claim 10, wherein identifying the second processor is further based on a temperature of the second processor, wherein the second processor is identified upon determining that the temperature of the second temperature is lower than the threshold by a predetermined amount

16. A system for managing processing workload for a vehicle, comprising:
a plurality of sensors, each sensor positioned at a location of the vehicle, and configured to measure a condition of its surrounding environment within a measurable range; and
a plurality of processors, each processor being positioned within the measurable range of respective sensors of the plurality of sensors, and having a processor type, wherein one of the plurality of processors is designated as a primary and the other processors are designated as secondary processors, the primary processor is configured to:
receive at least one measurement corresponding to a first processor of a plurality of processors installed in the vehicle;
determine that the at least one measurement has satisfied a threshold;
identify a second processor of the plurality of processors installed in the vehicle, based on a type of the second processor or a measurement of an environment associated with the second processor; and
distribute workload from the first processor to the second processor.

17. The system of claim 16, wherein the primary processor is further configured to manage the workload of the secondary processor based on a current workload of the secondary processor.

18. The system of claim 16, wherein the first and second processors are secondary processors.

19. The system of claim 16, wherein the first processor is the primary processor and the second processor is the secondary processor.

20. The system of claim 16, wherein the first processor is the secondary processor and the second processor is the primary processor.
